(19) United States
(12) Patent Application Publication
(10) Pub. No.: US 2026/0045643 A1
(43) Pub. Date: Feb. 12, 2026

(54) IMPROVED SEPARATOR FOR REDUCTION OF ACID STRATIFICATION IN A LEAD ACID BATTERY AND IMPROVED BATTERIES CONTAINING SAME

(71) Applicant: Daramic, LLC, Charlotte, NC (US)

(72) Inventors: J. Kevin Whear, Utica, KY (US); Margaret Roberts, Owensboro, KY (US); Mary Carver, Owensboro, KY (US); Andrew Goodby, Owensboro, KY (US); Anna Verderame, Charlotte, NC (US); Michael Maul, Waxhaw, NC (US); Joerg Deiters, Ettenheim (DE); Eric H. Miller, Philpot, KY (US); Serubbabel Sy, Owensboro, KY (US)

(21) Appl. No.: 19/100,571

(22) PCT Filed: Aug. 9, 2023
(86) PCT No.: PCT/US2023/029907

§ 371 Date: Feb. 2, 2025

Related U.S. Application Data
(60) Provisional application No. 63/396,683, filed on Aug. 10, 2022.

(51) Int. Cl. H01M 50/463; H01M 10/12; H01M 50/417; H01M 50/431; H01M 50/446

(52) U.S. Cl. CPC H01M 50/463; H01M 10/121; H01M 50/417; H01M 50/431; H01M 50/446; H01M 2220/20

(57) ABSTRACT

A lead acid battery separator having a first array of ribs extending from a first side of a backweb, and a second array of ribs extending from a second side of the backweb. Both the first array of ribs and the second array of ribs are cross-machine direction (CMD) ribs. In a flooded lead acid (FLA) or valve regulated lead acid (VRLA) battery, the CMD ribs extend in a direction that is parallel to a top and bottom of the battery. The separator helps reduce acid stratification issues, allowing for FLA batteries to be used as auxiliary batteries or enhanced flooded lead acid batteries (EFB), and further improving VRLA performance when used as auxiliary batteries.

### RELATED APPLICATION DATA

This application is a 371 US. Application which claims priority to PCT Application No.

PCT/US2023/029907, filed Aug. 9, 2023, which claims priority to U.S. Provisional Application No. 63/396,683, filed Aug. 10, 2022, and is incorporated herein in its entirety.

### FIELD

This application describes improved separators for reduction of acid stratification in a lead acid battery, particularly a flooded lead acid battery, enhanced flooded lead acid battery, or auxiliary lead acid battery, improved separators, separator membranes, coated membranes, silica coated polyolefin membranes, silica coated and carbon coated polyolefin membranes, flat sheet membranes, ribbed membranes, and cross-machine direction (CMD) ribbed membranes, and improved batteries containing such improved separators, separator membranes, coated membranes, silica coated polyolefin membranes, silica coated and carbon coated polyolefin membranes, flat sheet membranes, ribbed membranes, and/or cross-machine direction (CMD) ribbed membranes.

### BACKGROUND

Batteries operating at a partial state of charge are those operating at a state of charge between about 65% to about 90% or less. At partial charge, gas bubbles are not generated, and the internal mixing of the electrolyte is substantially reduced, leading to acid stratification within the battery. Acid stratification often leads to faster sulfation, reduced capacity, damage to the battery plates, and eventual battery failure.

In some instances, acid stratification can be avoided using VRLA (valve regulated lead acid) technology where the acid is immobilized by either a gelled electrolyte and/or by an absorbent glass mat (AGM) battery separator system. In contrast to the freely-fluid electrolyte in flooded lead acid batteries, in VRLA batteries the electrolyte is absorbed on a fiber or fibrous material, such as a glass fiber mat, a polymeric fiber mat, a gelled electrolyte, and so forth. However, VRLA battery systems are substantially more expensive to manufacture than flooded battery systems. VRLA-AGM technology in some instances, may be more sensitive to overcharging, may dry out in high heat, may experience a gradual decline in capacity, and may have a lower specific energy. Similarly, in some instances, gel VRLA technology may have higher internal resistance and may have reduced charge acceptance.

There is a growing need for 12 V lead auxiliary batteries, which are a critical on-board component for electric vehicles (EVs), and indeed the range of lower emission vehicles such as hybrid vehicles. The 12V lead auxiliary battery provides back up power for safety relevant features such as power steering and brake boosting. Not to mention, these auxiliary batteries are used to power electronic accessories in EVs and non-EVs, including comfort features such as radio, sound systems, security systems, cameras, and navigation systems.

Due to the harsh demands placed on these auxiliary batteries, they are operating at a partial state of charge, which as explained previously, makes them prone to acid stratification. In some cases, acid stratification in these auxiliary batteries may even be worse than in other types of batteries also operating at a partial state of charge.

Thus, there is a need for reducing acid stratification generally, and particularly in auxiliary batteries.

### SUMMARY

Disclosed herein are battery separators that when used in a lead acid battery operating under a partial state of charge as in an auxiliary battery improves one or more of the following properties: acid stratification by lowering the same; improved Dynamic Charge Acceptance (DCA) as measured by the VW DCA performance test, lowered water-loss as measured by the Volkswagon waterloss test VW 75073 published 03-2020, better Depth of Discharge found in VW 75073 Issue 2010-04 section 7.7 entitled “Cycles with 17.5% depth of discharge at (27+0/−2° C.), lowered residue formation, and higher oxidation resistance as measured by the PEROX 80 test as described in BCIS-03B section 22.

In one aspect, the lead acid battery separator comprises a backweb, a first array of ribs extending from a first side of a backweb, and a second array of ribs extending from a second side of the back web. Both the first and second array of ribs may be cross-machine direction (CMD) ribs. In some embodiments, at least one of the first array of ribs and the second array of ribs comprise individual ribs having different heights. In another embodiment, one or both of the first array of ribs and the second array of ribs comprise continuous ribs, discontinuous ribs, or angled discontinuous ribs.

The thickness of the separator backweb preferably ranges from 8 microns to 500 microns, 10 microns to 500 microns, 50 microns to 400 microns, or from 100 microns to 400 microns. In some embodiments, an overall separator thickness including ribs (if any) measured by BCI method (BCIS-03B Backweb Thickness Section 15 and Overall Thickness Section 16) preferably ranges from 8 to 1,200 microns, 10 to 1,200 microns, 50 to 1,100 microns, or from 600 to 1,100 microns.

In some embodiments, the battery separator is a filled polyolefin lead acid battery separator. In some embodiments, the filled polyolefin separator includes an oil in an amount from 5% to 20%. The oil may have an aniline point of the oil from 80° C. to 125° C.

In some embodiments, the filled polyolefin separator may comprise a siliceous filler. The ratio of siliceous filler to polyolefin may be 2.5:1 to 5:1.

In some embodiments, the separator may comprise rubber, rubber derivatives, latex, latex derivatives, or combinations thereof in an amount from 1% to 6% or from 1% to 3% by weight.

The separator may be a cut-piece, a sleeved, a wrapped, or an enveloped separator. Where the separator is wrapped or enveloped, through-slits may be formed in a bottom of the enveloped or wrapped separator.

The battery separator may comprise a surfactant and the surfactant is one or more selected from an ionic surfactant, a non-ionic surfactant, and an amphoteric surfactant.

The battery separator may, in some embodiments, comprise carbon on at least one of the first side and the second side.

In some other embodiments, the separator may comprise one or more selected from precipitated silica, dry finely divided silica, amorphous silica, fumed silica, friable silica, dispersible silica, alumina, talc, colloidal silica, super absorbent polymer, and fishbone meal between ribs on at least one of the first side or the second side thereof.

In another aspect, a lead acid battery comprising a separator as described hereinabove is described. In the battery, the CMD ribs extend parallel to a top and a bottom of the battery. In embodiments where carbon is provided on a side of the separator, the side of the separator with the carbon thereon will face a negative electrode of the battery. In embodiments where a silica is provided on a side of the separator, the side of the separator with the silica will face a positive electrode of the battery. In other embodiments where silica is provided on a side of the separator, the side of the separator with the silica thereon will face a negative electrode of the battery.

The battery may be any flooded lead acid battery where acid stratification may be an issue including an enhanced flooded battery (EFB), a starting, lighting, ignition (SLI) battery, an auxiliary battery, or the like.

In some embodiments, the battery may comprise a thickening agent in an electrolyte of the battery.

In another aspect, a vehicle comprising the lead acid battery described herein above is described. The lead acid battery may be a main lead acid battery or an auxiliary battery of the vehicle. The vehicle may be a truck, a car, or an electric vehicle such as a truck or a car. In another aspect, a battery separator with CMD ribs as described herein may be used in a valve regulated lead acid (VRLA) battery. The VRLA battery may comprise a composite separator that includes an absorptive glass mat (AGM) separator and a polyolefin separator with CMD ribs. In such an embodiment, an outer-facing surface of the polyolefin separator may comprise the CMD ribs, and a surface touching the AGM separator does not need CMD ribs, but may have them.

In another aspect, a vehicle comprising the VRLA battery described herein above is described. The lead acid battery may be a main lead acid battery or an auxiliary battery of the vehicle. The vehicle may be a truck, a car, or an electric car.

In another embodiment, a lead acid battery comprising the following is disclosed: two positive electrode plates; a negative electrode plate between the two positive electrode plates; and a separator. The separator comprises a backweb; a first array of ribs extending from a first side of the backweb; a second array of ribs extending from a second side of the backweb; and at least one of the first or second array of ribs comprising cross-machine direction (CMD) ribs. The separator is coated with a siliceous material on at least one side thereof. Additionally, the separator in this embodiment, encompasses the negative plate so that the CMD ribs face one or both of the positive electrode plates and extend in a direction parallel to a top or bottom of the battery.

The siliceous material is not so limited and may be one or more selected from the precipitated silica, dry finely divided silica, amorphous silica, fumed silica, friable silica, dispersible silica, and colloidal silica.

In another embodiment, a lead acid battery comprising: two positive electrode plates; a negative electrode plate between the two positive electrode plates; and a separator encompassing both positive electrode plates is described. The separator comprises a backweb, a first array of ribs extending from a first side of the backweb, a second array of ribs extending from a second side of the backweb, and at least one of the first or second array of ribs comprising cross-machine direction (CMD) ribs. Additionally, at least one side of the separator is coated with a siliceous material. The CMD ribs of the separator in this embodiment face positive electrode plates and extend in a direction parallel to a top or bottom of the battery.

The siliceous material is not so limited and may be one or more selected from the precipitated silica, dry finely divided silica, amorphous silica, fumed silica, friable silica, dispersible silica, and colloidal silica.

In another embodiment, a battery comprising at least one positive electrode plate, at least one negative electrode plate, and a battery separator is described. The separator comprises a profile on at least one side thereof that exhibits a surface area increase compared to a flat separator that is 35% or more, 40% or more, 60% or more, or 80% or more. Additionally, the separator is coated with silica on at least one or two sides thereof. At least certain embodiments, aspects or objects describe or provide improved separators for reduction of acid stratification in a lead acid battery, particularly a flooded lead acid battery, enhanced flooded lead acid battery, or auxiliary lead acid battery, improved separators, separator membranes, coated membranes, silica coated polyolefin membranes, silica coated and carbon coated polyolefin membranes, flat sheet membranes, ribbed membranes, and/or cross-machine direction (CMD) ribbed membranes, and/or improved batteries containing such improved separators, separator membranes, coated membranes, silica coated polyolefin membranes, silica coated and/or carbon coated polyolefin membranes, flat sheet membranes, ribbed membranes, and/or cross-machine direction (CMD) ribbed membranes.

### DESCRIPTION OF DRAWINGS

FIG. 1 includes illustrative cross-section drawings of exemplary battery separators as described herein, and their orientation relative to a top and bottom of the battery.

FIG. 2 includes illustrative cross section and side view drawings including multiple views of exemplary battery separators described herein.

FIG. 3 is a schematic side view drawing of a valve-regulated lead acid (VRLA) battery including exemplary separators described herein.

FIG. 4 is a schematic side view drawing of a flooded lead acid battery including exemplary separators as described herein.

FIG. 5 is a schematic side view drawing of a flooded lead acid battery including exemplary separators as described herein.

FIG. 6 is a schematic side view drawing of a flooded lead acid battery including exemplary separators as described herein.

FIG. 7 is a schematic side view drawing of a flooded lead acid battery including exemplary separators as described herein.

FIG. 8 is a schematic side view drawing of a valve-regulated lead acid (VRLA) battery including exemplary separators described herein.

FIG. 9 is a schematic side view drawing of a valve-regulated lead acid (VRLA) battery including exemplary separators described herein.

FIG. 10 is a schematic side view drawing of a valve-regulated lead acid (VRLA) battery including exemplary separators described herein.

FIG. 11 is a schematic side view drawing of a flooded lead acid battery including exemplary separators as described herein.

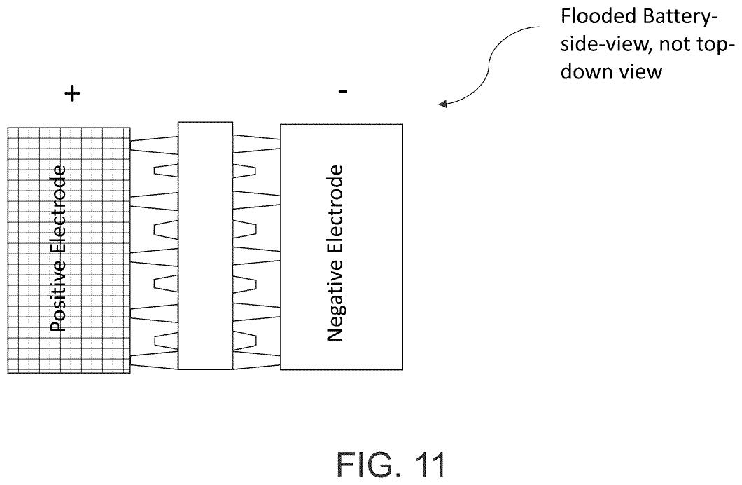

FIG. 12 is a schematic side view drawing of a pocket or envelope embodiment described herein such as a flooded lead acid battery including exemplary separators as described herein.

FIG. 13 includes cross section HIROX microscopic images of Profile 1 described herein with and without silica coating on a surface of the Profile 1.

FIG. 14 includes cross section HIROX microscopic images of Profile 2 described herein with and without silica coating on a surface and a drawing of a top-down view of the Profile 2.

FIG. 15 includes cross section HIROX microscopic images of Profile 3 described herein with and without silica coating on a surface and a drawing of a top-down view of the Profile 3.

FIG. 16 is a graph showing surface area increase compared to a flat microporous sheet with no rib profile.

FIG. 17 is a graph showing average voltage as a function of cycle in a 17.5 PSoC EoD Voltage test for embodiments described herein.

FIG. 18 Is a graph showing average voltage as a function of cycle life in a 17.5 PSoC EoD Voltage test for embodiments described herein.

FIG. 19 is a graph showing average voltage as a function of cycle life in a 17.5 PSoC EoD Voltage test for embodiments described herein.

FIG. 20 is a table showing the average percent acid pickup of the embodiments described herein.

### DETAILED SUMMARY

### Improved Battery Separator for Flooded Lead Acid (FLA) Battery

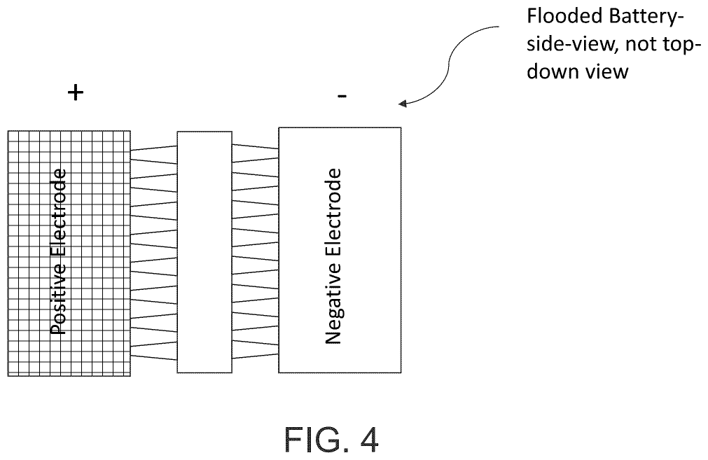

Disclosed herein are improved battery separators for use in flooded lead acid batteries that are prone to having acid stratification issues. Examples of flooded lead acid batteries that may have acid stratification issues include, but are not limited to, an enhanced flooded battery (EFB), a starting, lighting, igniting (SLI) battery, and the like. The improved battery separator described herein enables FLA batteries (see FIG. 4) to be used as an auxiliary battery in a vehicle or other device. As described above, acid stratification in auxiliary batteries is potentially worse than in other types of batteries (e.g., primary batteries), and use of FLA batteries as auxiliary batteries has been difficult.

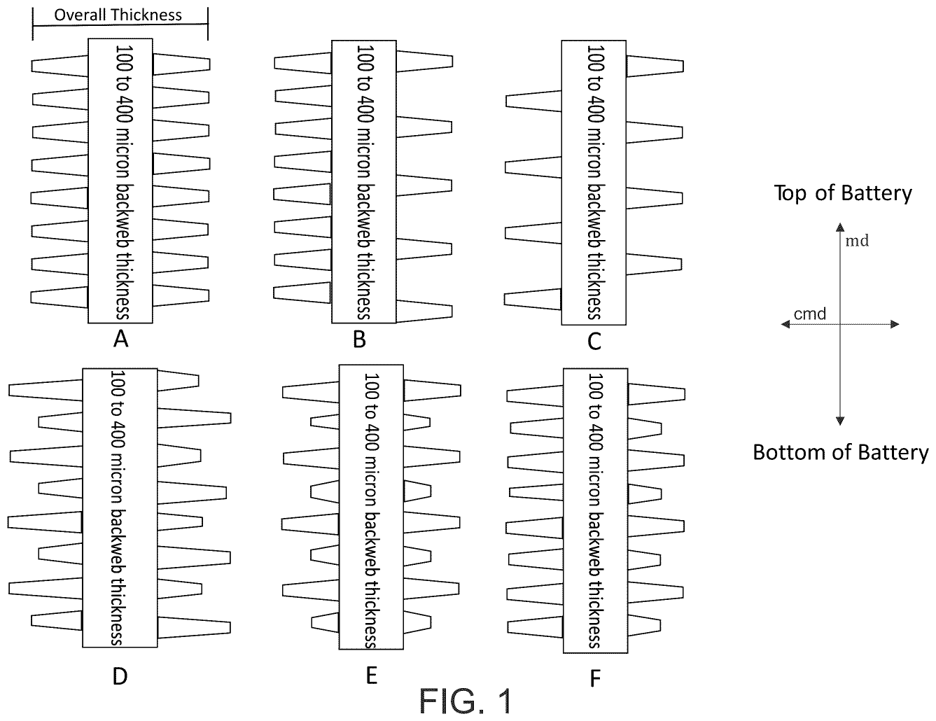

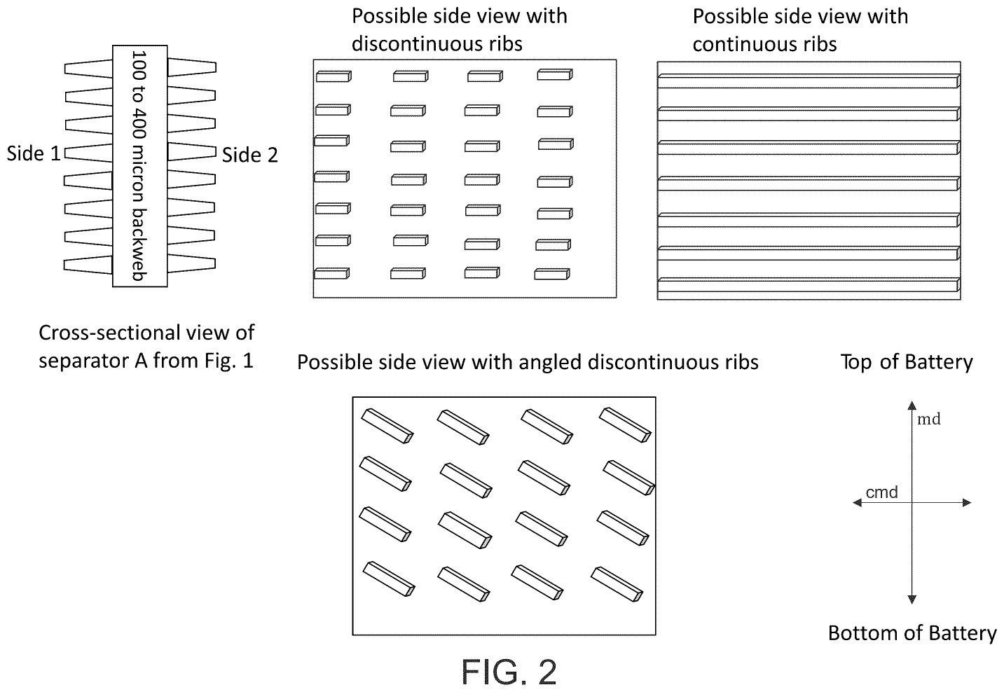

One improved battery separator described herein has a structure as follows: a backweb, and cross-machine direction (CMD) ribs extending from both sides of the backweb. As shown in FIG. 1 and FIG. 2, which includes exemplary battery separators with CMD ribs on both sides. When placed in a battery, the CMD ribs run parallel to a top and a bottom of the battery.

The backweb thickness of the battery separators described herein may, in some embodiments, preferably be between about 100 microns to about 400 microns, from 100 microns to 350 microns, from 100 microns to 300 microns, from 100 microns to 250 microns, from 100 microns to 200 microns, or from 100 microns to 150 microns. Backweb thickness is measured using BCI method (BCIS-03B Backweb Thickness Section 15).

The overall thickness of the battery separators described herein is calculated by adding the backweb thickness, the height of the tallest rib on a first side, and the height of a tallest rib on a second side. See FIG. 1. It is measured using BCI method (BCIS-03B Overall Thickness Section 16). Preferably, the overall thickness is about equal to the required plate spacing in the battery. Overall thickness ranges from about 500 microns to about 1,100 microns, from 500 microns to 1,000 microns, from 500 microns to 900 microns, from 500 microns to 800 microns, from 500 microns to 700 microns, or from 500 microns to 600 microns. In an auxiliary battery, plate spacing is typically between about 600 microns and 1,000 microns, so for this application overall thickness should fall within this range.

The ribs on the first side and the second side may be the same or different. For example, the CMD ribs may be continuous on both sides, continuous on one side, but not on the other, discontinuous on both sides, or discontinuous on one side, but not on the other. The CMD ribs on the first side and the second side may be the same height or different heights. In addition, rib heights may be provided on the same side. Further, CMD rib heights on a given side may be the same or different. For example, see D, E, and F in FIG. 1. In some embodiments, the CMD rib spacing on the first side may be the same or different than the spacing on the second side. Rib spacing may also be variable on the same side. A combination of different rib heights and spacings may also be combined on one side.

Rib spacing is not so limited, but is preferably from 0.25 mm to 12 mm, from 0.5 mm to 12 mm, from 1 mm to 12 mm, from 2 to 12 mm, from 3 to 12 mm, from 4 to 12 mm, from 5 mm to 12 mm, from 6 mm to 12 mm, from 7 mm to 12 mm, from 8 mm to 12 mm, from 9 mm to 12 mm, from 10 mm to 12 mm, or from 11 mm to 12 mm.

In embodiments including discontinuous ribs, the ribs may be angled or not angled. For example, for an angled rib, the angle of the rib may be 1 degree or more or less than 180 degrees, or the angle of the rib may be from 181 degrees or greater to less than 360 degrees.

The composition of the lead acid battery separator disclosed herein is not so limited, but preferably includes natural or synthetic materials, such as polyolefin, polyethylene, polypropylene, phenolic resin, PVC, rubber, synthetic wood pulp (SWP), glass fibers, cellulosic fibers, or combinations thereof. The polyolefin is preferably, but not limited to, a polyethylene or a polypropylene. In some preferred embodiments, the polyethylene is a high or ultra-high molecular weight polyethylene.

In some preferred embodiments, the battery separator may be a filled-polymer lead acid battery separator, preferably a filled polyolefin separator. A filled polyolefin separator comprises a polyolefin and a filler. Suitable fillers include siliceous fillers, such as: silica, mica, montmorillonite, kaolinite, asbestos, talc, diatomaceous earth, vermiculite, natural and synthetic zeolites, cement, calcium silicate, clay, aluminum silicate, sodium aluminum silicate, aluminum polysilicate, alumina silica gels, and glass particles. These siliceous fillers are water soluble. In addition to the siliceous fillers, other particulate substantially water-insoluble fillers may also be employed. Examples of such optional fillers include carbon black, activated carbon, carbon fibers, charcoal, graphite, titanium oxide, iron oxide, copper oxide, zinc oxide, lead oxide, tungsten, antimony oxide, zirconia, magnesia, alumina, molybdenum disulfide, zinc sulfide, barium sulfate, strontium sulfate, calcium carbonate, and magnesium carbonate.

In embodiments where a siliceous filler is used, a ratio of siliceous filler to polyolefin is from 2.5:1.0 to 5.0:1.0, from 3.0:1.0 to 5.0:1.0, from 3.5:1.0 to 5.0:1.0, from 4.0:1.0 to 5.0:1.0, or from 4.5:1.0 to 5.0.1.0

The lead acid battery separator may comprise a plasticizer, which is typically a liquid at room temperature, and usually is a processing oil such as paraffinic oil, naphthenic oil, or an aromatic oil. An amount of oil in the final battery separator may be from 5% to 20%, from 7% to 20%, from 10% to 20%, from 13% to 20%, from 15% to 20%, from 17% to 20%, or from 18% to 20%. The processing oil may have an aniline point of 50° C. to 125° C., 60° C. to 125° C., 70° C. to 125° C., 80° C. to 125° C., 90° C. to 125° C., 100° C. to 125° C., 110° C. to 125° C., 120° C. to 125° C.

In some embodiments, one or more of a rubber, a rubber derivative, a latex, and a latex derivative may be added in an amount from 1% to 3%, 1.5% to 3%, 2% to 3%, or 2.5% to 3%.

As used herein, rubber shall describe, rubber, latex, natural rubber, synthetic rubber, cross-linked or uncross-linked rubbers, cured or uncured rubber, crumb or ground rubber, or mixtures thereof. Exemplary natural rubbers may include one or more blends of polyisoprenes, which are commercially available from a variety of suppliers. Exemplary synthetic rubbers include methyl rubber, polybutadiene, chloropene rubbers, butyl rubber, bromobutyl rubber, polyurethane rubber, epichlorhydrin rubber, polysulphide rubber, chlorosulphonyl polyethylene, polynorbornene rubber, acrylate rubber, fluorine rubber and silicone rubber and copolymer rubbers, such as styrene/butadiene rubbers, acrylonitrile/butadiene rubbers, ethylene/propylene rubbers (“EPM” and “EPDM”) and ethylene/vinyl acetate rubbers. The rubber may be a cross-linked rubber or an uncross-linked rubber; in certain preferred embodiments, the rubber is uncross-linked rubber. In certain embodiments, the rubber may be a blend of cross-linked and uncross-linked rubber.

In some embodiments, the separator comprises a surfactant therein, thereon, or both therein and thereon. The surfactant comprises one or more selected from an ionic surfactant, a non-ionic surfactant, and an amphoteric surfactant.

The nonionic surfactant is not so limited and may be at least one selected from the following: fatty alcohols, cetyl alcohols, stearyl alcohols, pentaethylene glycol monododecyl ether, polyoxypropylene glycol alkyl ethers, polyoxyethylene glycol, octylphenol ethers, polyoxyethylene glycol alkyl ethers, octaethylene glycol monododecyl ether, polyoxyethylene glycol alkylphenol ethers, polyoxyethylene glycol sorbitan alkyl esters, oleyl alcohols, block copolymers of polyethylene glycol, block copolymers of polypropylene glycol, glucoside alkyl ethers, decyl glucoside, lauryl glucoside, octyl glucoside, nonoxynol-9, glycerol alkyl esters, polysorbates, sorbitan alkyl esters, glyceryl laurate, cocamide, costearyl alcohols, methallyl-capped non-ionic surfactant, polyol fatty acid esters, polyethyoxylated esters, polyethoxylated fatty alcohols, alkyl polysaccharides, alkyl polyglycosides, amine ethoxylates, sorbitan fatty acid ester ethoxylates, organosilicone based surfactants, ethylene vinyl acetate terpolymers, ethoxylated alkyl aryl phosphate esters, sucrose esters of fatty acids, polyethoxylated alcohols, polyethylene oxide, acid-soluble sugars, sucrose esters of fatty acids, organic fatty acids, hydroxyl acid, nonionic surfactant, octylphenol ethoxylate surfactant, octylphenol ethoxylate nonionic surfactant, and combinations thereof.

In some embodiments, the nonionic surfactant wherein the non-ionic surfactant has a cloud point rating greater than about 15° C., greater than about 20° C., or greater than about 25° C.

In some embodiments, the nonionic surfactant may have the following structures:

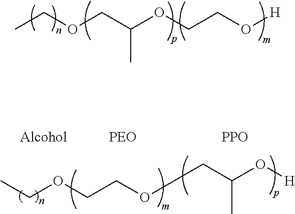

In the foregoing structures n may be an integer from 5 to 20 or from 9 to 17, m may be an integer from 1 to 15 or from 6 to 10, and p may be an integer from 0 to 10 or from 0 to 7.

The ionic surfactant may be a cationic surfactant, an anionic surfactant, or an amphoteric surfactant.

In some embodiments, the ionic surfactant may be at least one selected from the following: sulfates; alkyl sulfates; ammonium lauryl sulfates; sodium lauryl sulfates; alkyl ether sulfates; sodium laureth sulfate; sulfonates, docusates; dioctyl sodium sulfosuccinate; alkyl benzene sulfonates; phosphates; alkyl ether phosphates; carboxylates; alkyl carboxylates; fatty acid salts; sodium stearate; sodium lauroyl sarcosinate; Alkyltrimethylammonium; cetylpyridinium; polyethoxylated tallow amine; benzalkonium; benzethonium; dimethyldioctadecylammonium; dioctadecyldimethylammonium salts of alkyl sulfates; alkylarylsulfonate salts; alkylphenol-alkylene oxide addition products; soaps; alkyl-naphthalene-sulfonate salts; one or more sulfo-succinates, such as an anionic sulfo-succinate; dialkyl esters of sulfo-succinate salts; amino compounds (primary, secondary or tertiary amines; quaternary amines; block copolymers of ethylene oxide and propylene oxide; various polyethylene oxides; salts of mono and dialkyl phosphate esters, and mixtures thereof.

In some embodiments, the ionic surfactant may be an anionic surfactant having the following structure:

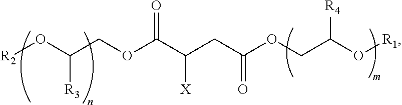

where n is an integer from 0 to 10, m is an integer from 0 to 10, R1 is H, a C1 to C10 linear or branched, saturated or unsaturated alkyl group, a C1 to C10 fatty alcohol, a C1 to C10 alcohol, or an aromatic group, and R2 is H, a C1 to C10 linear or branched, saturated or unsaturated alkyl group, a C1 to C10 linear or branched, saturated or unsaturated fatty alcohol, a C1 to C10 linear or branched, saturated or unsaturated alcohol, or an aromatic group, n and m are the same or different, R1 and R2 are the same or different, R3 is hydrogen or methyl, R4 is hydrogen or methyl, R3 and R4 are the same or different, X is a negatively charged groups such as SO3-, COO—, PO4-2, and the like. A positive counter ion to the anionic surfactant is also present and may be at least one of Na⁺, K⁺, Li⁺, NH₄⁺, Ca₂⁺, Mg₂⁺, and the like.

In some embodiments, the ionic surfactant may be an anionic surfactant having the following formula:

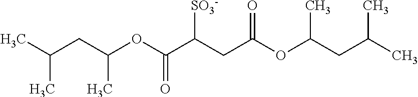

The surfactant may be added in an amount of 15 grams per square meter (gsm), or less, 14 gsm or less, 13 gsm or less, 12 gsm or less, 11 gsm or less, 10 gsm or less, 9 gsm or less, 8 gsm or less, 7 gsm or less, 6 gsm or less, 5 gsm or less, 4 gsm or less, 3 gsm or less, 2 gsm or less, or 1 gsm or less. Use of a surfactant may improve function of a flooded lead acid battery, for example, by lowering water loss.

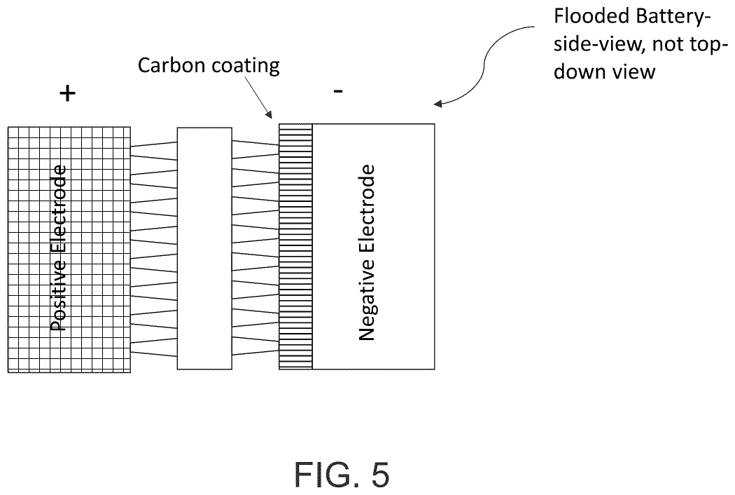

In some other embodiments, carbon may be provided on one or both surfaces of the separator. The carbon may be provided to a thickness less than 10 microns, less than 9 microns, less than 8 microns, less than 7 microns, less than 6 microns, less than 5 microns, less than 4 microns, less than 3 microns, less than 2 microns, or less than 1 micron. The coating amount may be 15 gsm or less, 14 gsm or less, 13 gsm or less, 12 gsm or less, 11 gsm or less, 10 gsm or less, 9 gsm or less, 8 gsm or less, 7 gsm or less, 6 gsm or less, 5 gsm or less, 4 gsm or less, 3 gsm or less, 2 gsm or less, or 1 gsm or less. The coating surface may appear cracked or not cracked. In some preferred embodiments, carbon may be provided on a side of the separator that faces the negative electrode of the flooded lead acid battery. This arrangement may improve charge acceptance in the battery. This arrangement is shown in FIG. 5.

In some embodiments, the separator can be a cut-piece separator, a sleeved separator, a wrapped separator, or a pocket or an enveloped separator. In embodiments where the separator is wrapped or enveloped, slits or openings may be created in the bottom of the separator (i.e., part closest to the bottom of the battery). The slits or openings improve mixing by allowing acid to come into the wrap or envelope from the bottom, while the wrap or envelope holds the electrode plates.

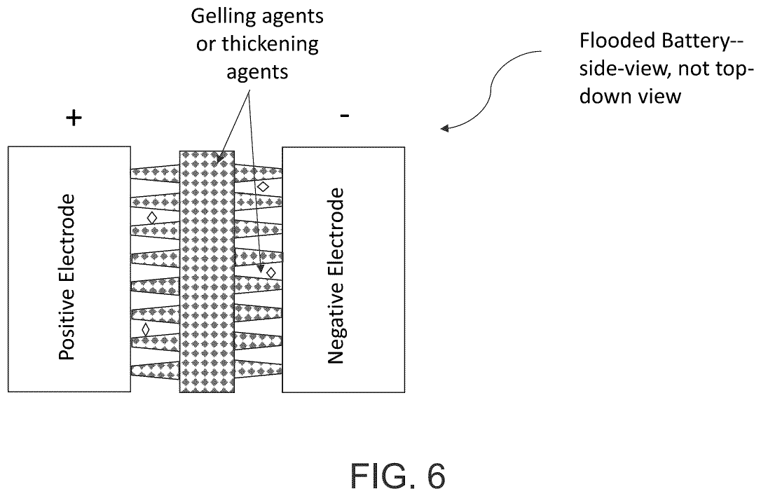

In some embodiments, a gelling or thickening agent may be added to the flooded lead acid battery. For example, the gelling or thickening agent may be added to the electrolyte via direct addition into the electrolyte or via the separator. FIG. 6 depicts an embodiment where gelling or thickening agents are added via the separator. The gelling or thickening agent increases the viscosity of the electrolyte. The more viscous electrolyte (acid) is expected to stratify more slowly and may cling to the separator. This is expected to further enhance the effects of the invention described herein.

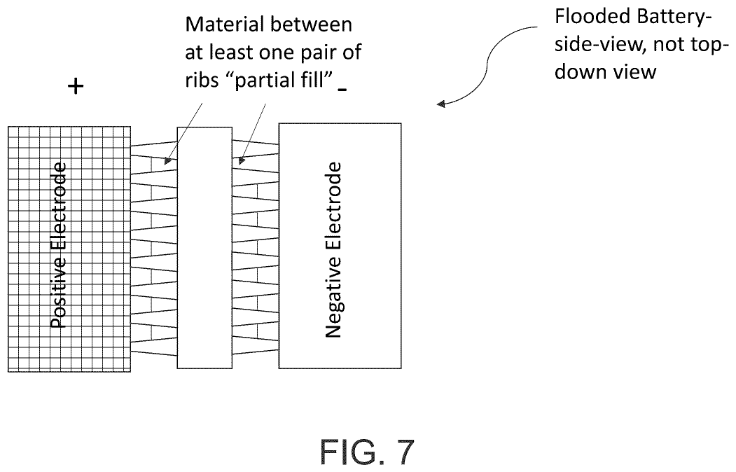

In other embodiments, one or more materials may be provided between at least one pair of ribs on a first side or a second side of the separator. The space between the at least one pair of ribs may be partially filled or completely filled with the material. For example, see FIG. 7, showing a “partial fill.” In some embodiments, the material may be one or more selected from precipitated silica, dry finely divided silica, amorphous silica, fumed silica, friable silica, dispersible silica, alumina, talc, super absorbent polymers, and fishbone meal. Super absorbent polymers may be provided as powders, fibers, filaments, liquids, or precursor chemicals. Without wishing to be limited, it is believed that these materials will absorb and even hold the electrolyte (acid) in place further enhancing the effects of the present invention. The material used is not so limited as long as it is acceptable for use in a flooded lead acid battery and absorbs (and possibly holds) acid. The material may be provided with or without a binder. Other additives may or may not be added.

In accordance with certain embodiments, aspects or objects, a coated membrane or battery separator has a silica coating on one or both sides of a microporous polyolefin flat sheet membrane, such as a silica filled PE membrane.

In accordance with other certain embodiments, aspects or objects, a coated membrane or battery separator has a silica coating on one side and a carbon coating on the other side of a microporous polyolefin flat sheet membrane, such as a silica filled PE membrane.

In accordance with still other certain embodiments, aspects or objects, a coated membrane or battery separator has a silica coating on both sides of a microporous polyolefin flat sheet membrane, such as a silica filled PE membrane.

In accordance with selected embodiments, aspects or objects, a lead acid battery separator, comprises:
a polyolefin backweb; and
a silica coating on at least one side of the backweb.

The above battery separator, having a silica coating on both sides of the backweb.

The above battery separator, having a carbon coating on the other side of the backweb.

The above battery separator, having ribs or protrusions on at least one side of the backweb.

The above battery separator, having a 10 to 500 micron backweb thickness. The above battery separator, having a 10 to 1,200 micron overall separator thickness including any ribs.

In accordance with other selected embodiments, aspects or objects, a flat sheet or non-ribbed polyolefin membrane, comprises:
a polyolefin backweb; and
a silica coating on at least one side of the backweb.

The above flat sheet, having a silica coating on both sides of the backweb.

The above flat sheet, having a carbon coating on the other side of the backweb.

The above flat sheet, having a 10 to 500 micron backweb thickness.

### Improved Battery Separator for Valve Regulated Lead Acid (VRLA) Battery

As described below, the improved battery separators may also be used in valve-regulated lead acid (VRLA) batteries, which are types of batteries that do not typically experience acid stratification issues or do not experience acid stratification issues to the extent that flooded lead acid batteries do.

VRLA batteries are structurally different than flooded lead acid battery. For example, one difference is that VRLA batteries are sealed, while flooded batteries are not. Another notable difference is that in a VRLA battery the electrolyte is immobilized, while in a flooded lead acid battery there is free-flowing electrolyte.

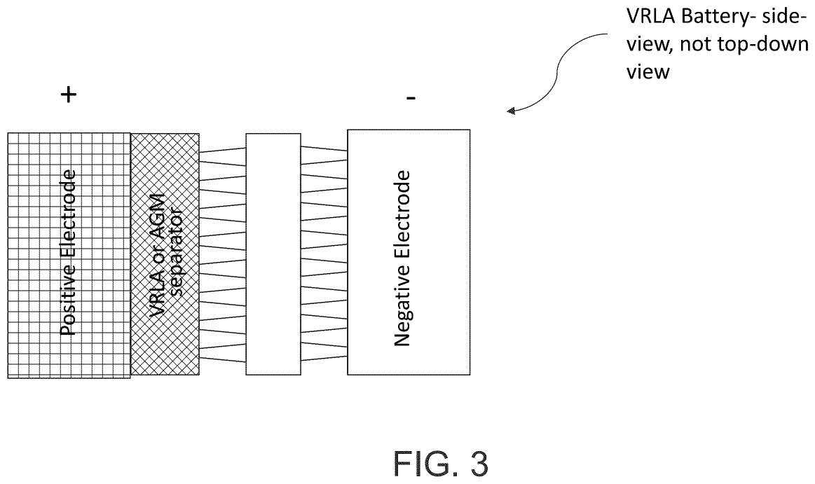

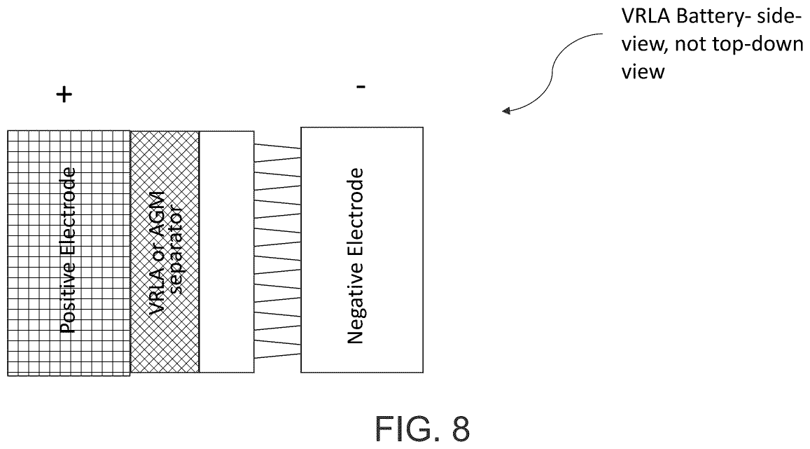

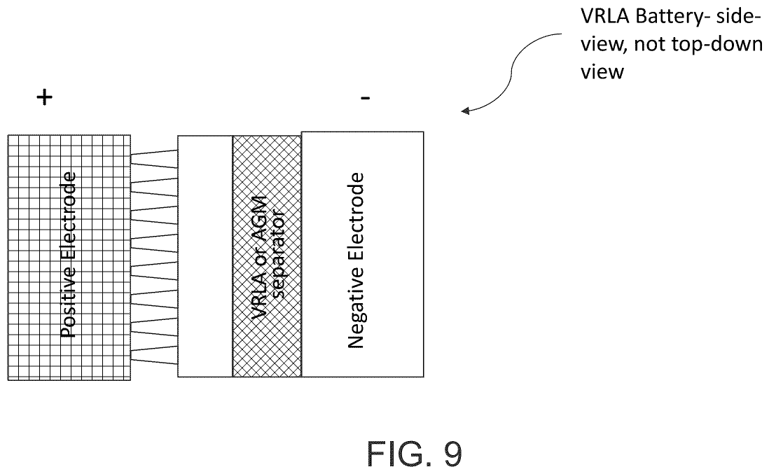

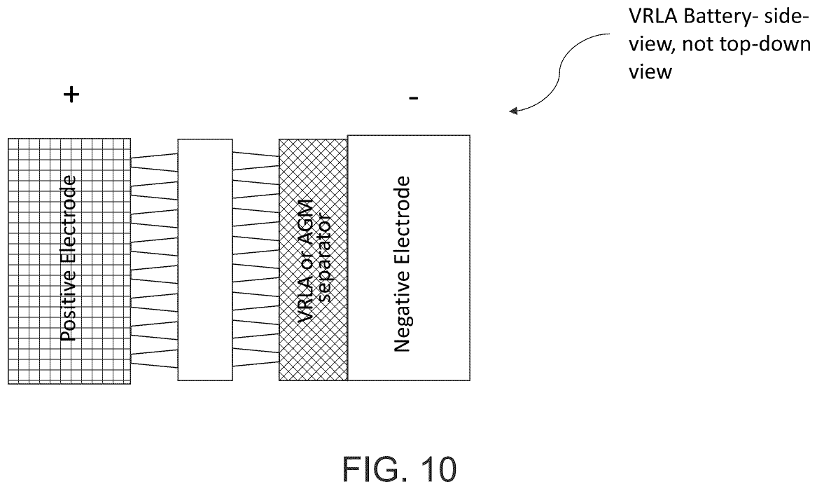

In some embodiments herein, a VRLA battery comprises a positive and negative electrode, and both a VRLA separator (i.e., an absorbent glass mat (AGM) separator), and an improved separator as described hereinabove, between the positive and negative electrode. The improved separator described herein may comprises cross-machine-direction (CMD) ribs that extend parallel to a top and a bottom of the battery. The CMD ribs may face toward the VRLA/AGM separator and/or away from the VRLA/AGM separator. See FIG. 3, FIG. 8, FIG. 9, and FIG. 10. In some preferred embodiments, the CMD ribs may be provided so that they are facing away from the VRLA or AGM separator. See FIG. 8 and FIG. 9 where the CMD ribs are only facing away from the VRLA or AGM separator. Benefits of this arrangement may include, reducing compressibility of the separator, further benefits include improving or even eliminating acid stratification issues. When the CMD ribs face the positive electrode, this may also help with shedding of the positive active material (PAM), or PAM shedding.

### Batteries and Vehicles

As described above, the battery separators described herein may be used in either flooded lead acid batteries or in valve-regulated lead acid batteries.

In preferred embodiments, the battery separators described herein are used in flooded lead acid batteries where lower acid stratification is desired. This may include enhance flooded batteries (EFBs), start-light-ignite (SLI) batteries, or the like. The battery may be a main battery or an auxiliary battery. It is believed that the improved battery separators described herein may allow for the use of flooded lead acid batteries as auxiliary batteries, which is currently difficult. An auxiliary battery, as understood by one skilled in the art, an auxiliary battery is not primarily responsible for starting the engine of a vehicle, though it may be a backup.

In other preferred embodiments, the battery separators described herein may be used in a valve-regulated lead acid (VRLA) battery, particularly a VRLA battery for use as an auxiliary battery in a vehicle. The separator may also be used in a VRLA battery that is a main battery in a vehicle.

Vehicles as described herein may include trucks, cars, electric cars or trucks, or the like.

### EXAMPLES

To prepare the Examples, three different silica-filled polyethylene separators with 5-20% processing oil were obtained. The separators had three different rib profiles-profile 1, profile 2, profile 3.

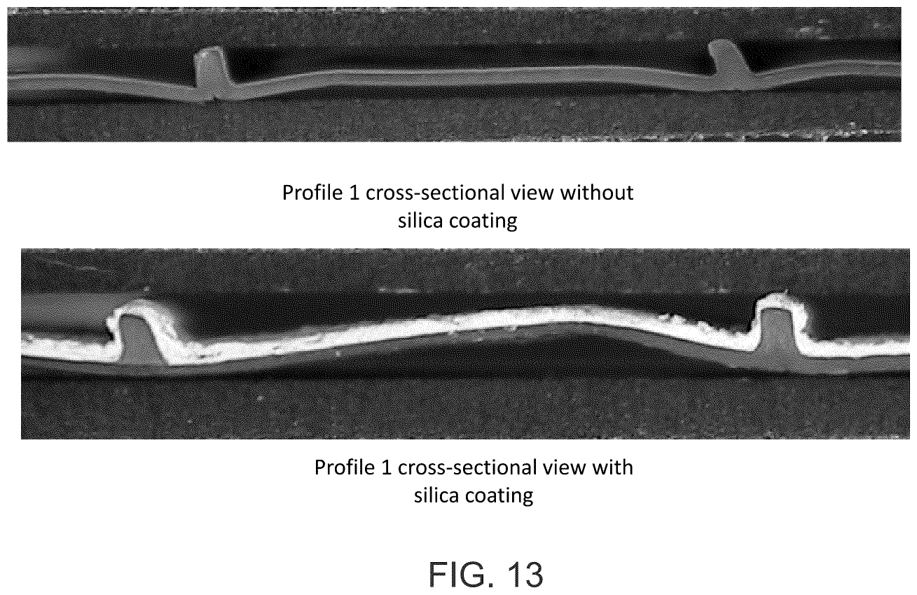

Profile 1 (NX) is where on one side of the separator the rib profile is a continuous vertical rib, where adjacent rib pitch is approximately 7.3 mm. On the other side, the rib profile is a continuous rib that runs perpendicular to the ribs on the other side (i.e., a cross-rib). See FIG. 13.

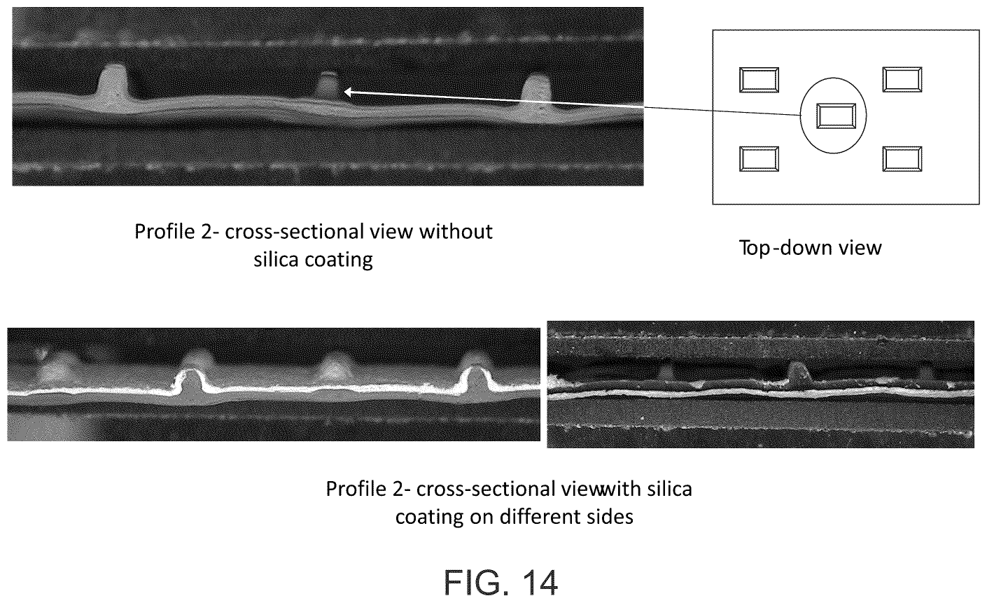

Profile 2 (19X) is where on one side of the separator the rib profile is a discontinuous vertical rib, where adjacent rib pitch is approximately 3.5 mm. On the other side, the rib profile is a continuous rib that runs perpendicular to the ribs on the other side (i.e., a cross-rib). See FIG. 14.

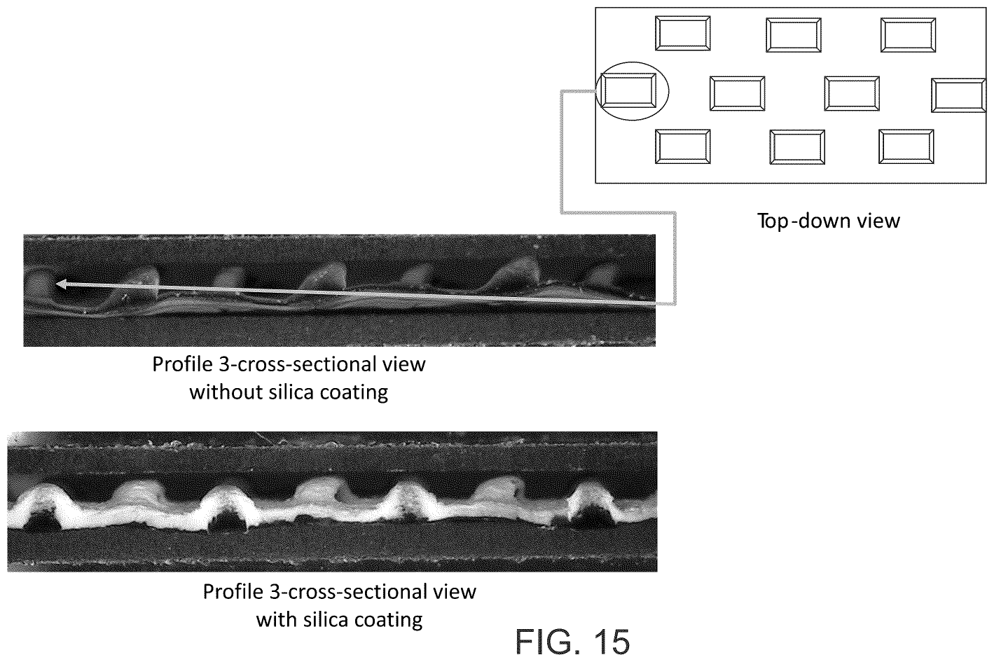

Profile 3 (38X) is where on one side of the separator the rib profile is a discontinuous vertical rib, where adjacent rib pitch is approximately 1.8 mm. On the other side, the rib profile is a continuous rib that runs perpendicular to the ribs on the other side (i.e., a cross-rib). See FIG. 15.

### Surface Area Calculation:

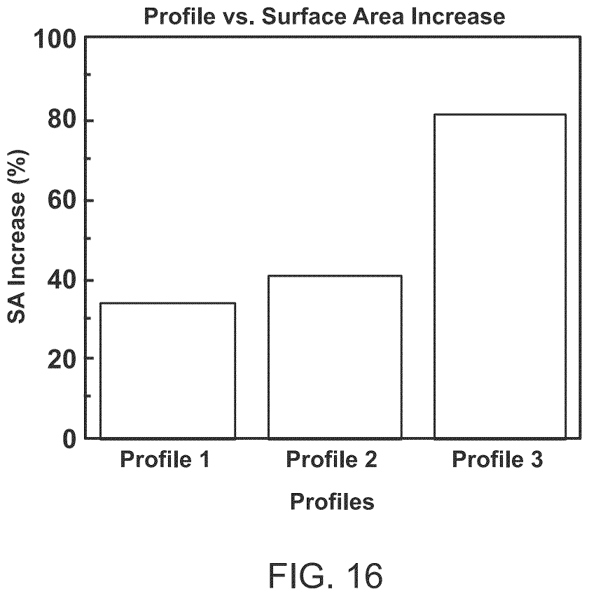

Separators having Profile 1, Profile 2, and Profile 3 using rib dimensions (e.g., height, pitch, width, etc.) obtained using a Hirox Microscope. A sample area of the separator (e.g., 2 inches by 2 inches) was used for the measurement. Surface area is compared to a flat separator (e.g., with no rib profile). FIG. 16 shows the surface area increase compared to a flat separator (0% increase).

### Percent Acid Pickup/Takeup:

Separators were cut 2 inches by 2 inches, dried in a vented 110° C. oven for 5 minutes and then weighed Weight_{Initial}. Samples were then soaked for 10 minutes in 1.28 Sp. Gr. Sulfuric acid. They were patted dry with 4 paper towels and allowed to drip dry for 15 seconds. A second weight was obtained Weight_{Final}. The percent acid pickup was calculated using the following formula: (Weight_{Final}−Weight_{Initial})/Weight_{Initial}×100.

### Example 1a, 1b, and 1c (Control)

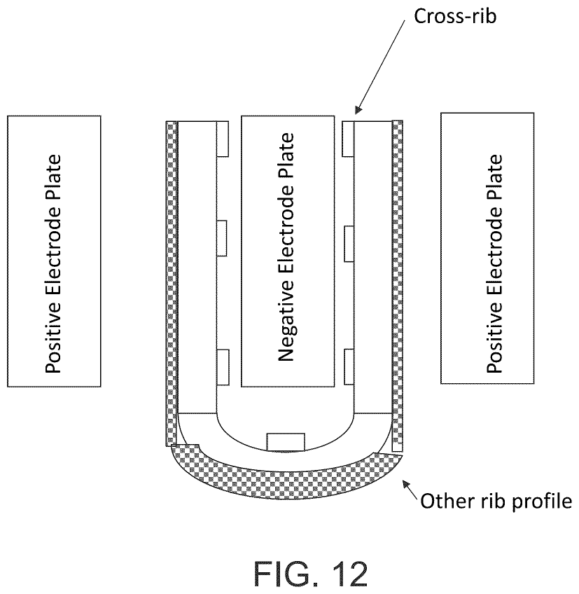

A separator having profile 1 was provided and a battery cell with two positive electrode plates and one negative electrode plate was prepared. The negative electrode plate was wrapped with the separator so that the cross-rib faced the negative plate and the other rib profile faced a positive plate. An Example like Examples 1a, 1b, and 1c is exemplified in FIG. 12. In the battery cell, the cross-rib runs parallel to a top and bottom of the battery cell.

### Example 2a, 2b, and 2c

A separator having profile 1 was provided and a battery cell with two positive electrode plates and one negative electrode plate was prepared. The negative electrode plate was wrapped with the separator so that the cross-rib faced the negative plate and the other rib profile faced a positive plate. The side of the separator facing the positive plate was coated with a layer of silica in this example. In the battery cell, the cross-rib runs parallel to a top and bottom of the battery cell.

### Examples 3a, 3b, and 3c (Control)

A separator having profile 2 was provided and a cell with two positive electrode plates and one negative electrode plate was prepared. The negative electrode plate was wrapped with the separator so that the cross-rib faced the negative plate and the other rib profile faced a positive plate. In the battery cell, the cross-rib runs parallel to a top and bottom of the battery cell.

### Examples 4a, 4b, and 4c (Control)

A separator having profile 2 was provided and a cell with two positive electrode plates and one negative electrode plate was prepared. The negative electrode plate was wrapped with the separator so that the cross-rib face a positive plate and the other rib profile face the negative plate. In the battery cell, the cross-rib runs parallel to a top and bottom of the battery cell.

### Examples 5a, 5b, and 5c

A separator having profile 2 was provided and a battery cell with two positive electrode plates and one negative electrode plate was prepared. The negative electrode plate was wrapped with the separator so that the cross-rib faced the negative plate and the other rib profile faced a positive plate. The side of the separator facing the positive plate was coated with a layer of silica. In the battery cell, the cross-rib runs parallel to a top and bottom of the battery cell.

### Examples 6a, 6b, and 6c

A separator having profile 2 was provided and a battery cell with two positive electrode plates and one negative electrode plate was prepared. The negative electrode plate was wrapped with the separator so that the cross-rib face a positive plate and the other rib profile face the negative plate. The side of the separator facing the negative plate was coated with a layer of silica. In the battery cell, the cross-rib runs parallel to a top and bottom of the battery cell.

### Example 7a, 7b, and 7c

A separator having profile 2 was provided and a battery cell with two positive electrode plates and one negative electrode plate was prepared. The negative electrode plate was wrapped with the separator so that the cross-rib faced the negative plate and the other rib profile faced a positive plate. The side of the separator facing the negative plate was coated with a layer of silica. In the battery cell, the cross-rib runs parallel to a top and bottom of the battery cell.

### Example 8a, 8b, and 8c

A separator having profile 2 was provided and a battery cell with two positive electrode plates and one negative electrode plate was prepared. The negative electrode plate was wrapped with the separator so that the cross-rib face a positive plate and the other rib profile face the negative plate. The side of the separator facing the positive plate was coated with a layer of silica. In the battery cell, the cross-rib runs parallel to a top and bottom of the battery cell.

### Example 9a, 9b, and 9c (Control)

A separator having profile 3 was provided and a battery cell with two positive electrode plates and one negative electrode plate was prepared. The negative electrode plate was wrapped with the separator so that the cross-rib faced the negative plate and the other rib profile faced a positive plate. In the battery cell, the cross-rib runs parallel to a top and bottom of the battery.

### Example 10a, 10b, and 10c

A separator having profile 3 was provided and a battery cell with two positive electrode plates and one negative electrode plate was prepared. The negative electrode plate was wrapped with the separator so that the cross-rib faced the negative plate and the other rib profile faced a positive plate. The side of the separator facing the positive plate was coated with a layer of silica. In the battery cell, the cross-rib runs parallel to a top and bottom of the battery.

Examples similar to those described above may be prepared where the 2 electrode positive plates are each wrapped instead of the one negative electrode plate.

### Testing and Results

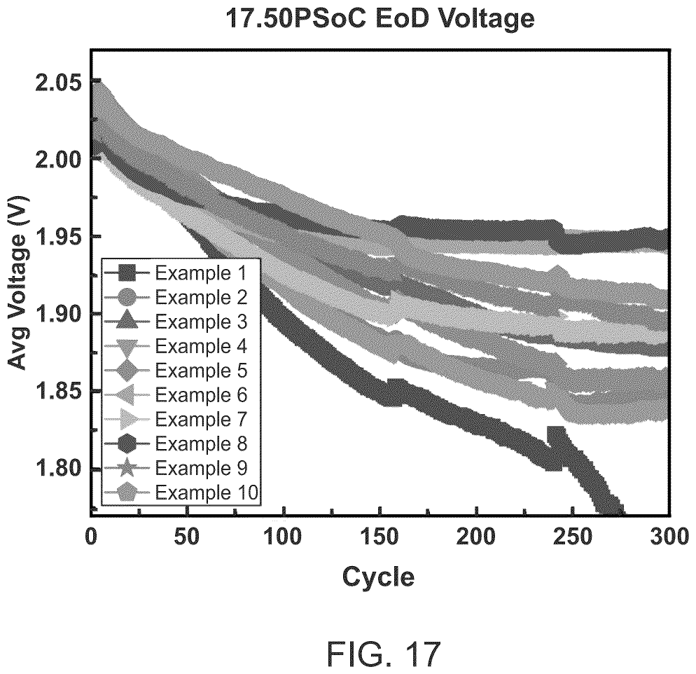

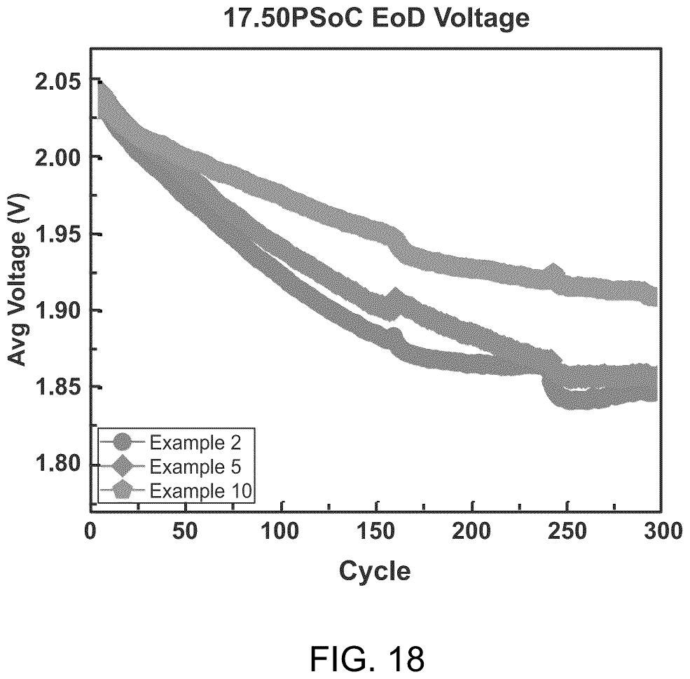

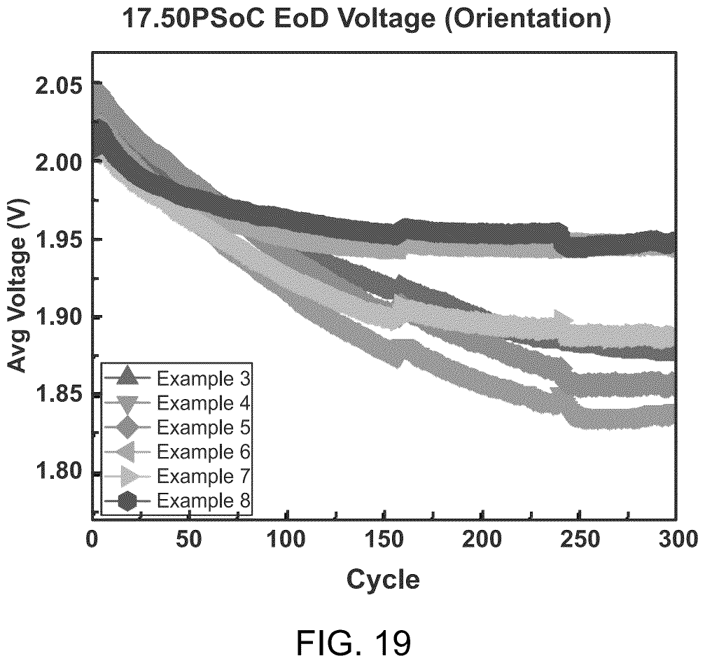

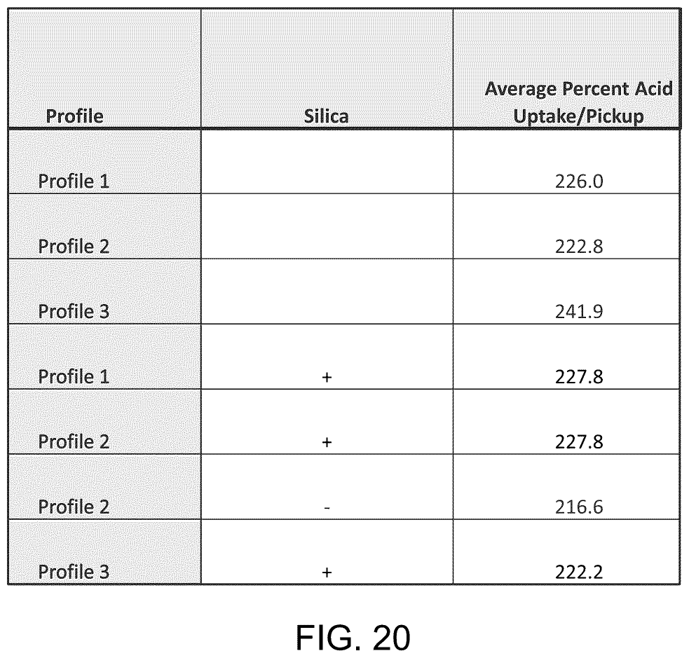

The battery cells from each example were tested according to the 17.5% Partial State of Charge (PSoC) End of Discharge (EoD) test. This test is found in VW 75073, Issue 2010-04, section 7.7 entitled “Cycles with 17.5% depth of discharge at (27+0/−2° C.)” Results for each Example are reported as an average (e.g., of 10a, 10b, and 10c) are found in FIG. 17. FIG. 18 includes select Examples from FIG. 17 illustrating increased performance of silica-coated examples as the surface area of the separator profile increases. Average voltage at end of discharge is as follows: Example 10 (Profile 3)>Example 5 (Profile 2)>Example 2 (Profile 1). As shown in FIG. 16, Profile 3 exhibits a greater surface area compared to Profile 2 and much greater surface area increase compared to Profile 1. The fact that using a separator with surface area increase profile (e.g. 35% or more surface area increase compared to a flat sheet) and a silica coating produces much better results when battery cells are tested according to the 17.5% Partial State of Charge (PSoC) End of Discharge (EoD) is unexpected. FIG. 19 also includes select Example from FIG. 17 to illustrate the following effects. For example, it shows that the addition of silica coating to embodiments where the cross-rib faces the positive plate drastically improves performance. For example, compare, Example 4 (cross-rib faces the positive with no silica coating) with Example 6 (cross-rib faces the positive and silica coating faces the negative) and Example 8 (cross-rib faces the positive and silica coating faces the positive too). Notably, Example 4 is one of the worst performing Examples and Examples 6 and 8 are unexpectedly the best performing. The placement of the silica coating does not appear to matter, but it is necessary for the improved performance. It is also notable that while FIG. 20 shows that there was statistically little difference between the overall average percent acid uptake/pickup, the samples performed very differently in the 17.5% Partial State of Charge (PSoC) End of Discharge (EoD) test indicating an acid stratification difference in the examples.

At least certain embodiments, aspects or objects describe or provide improved separators for reduction of acid stratification in a lead acid battery, particularly a flooded lead acid battery, enhanced flooded lead acid battery, or auxiliary lead acid battery, improved separators, separator membranes, coated membranes, silica coated polyolefin membranes, silica coated and carbon coated polyolefin membranes, flat sheet membranes, ribbed membranes, and cross-machine direction (CMD) ribbed membranes, and improved batteries containing such improved separators, separator membranes, coated membranes, silica coated polyolefin membranes, silica coated and carbon coated polyolefin membranes, flat sheet membranes, ribbed membranes, and/or cross-machine direction (CMD) ribbed membranes.

At least selected embodiments, aspects or objects describe or provide a lead acid battery separator having a first array of ribs extending from a first side of a backweb, and a second array of ribs extending from a second side of the backweb. Both the first array of ribs and the second array of ribs are cross-machine direction (CMD) ribs. In a flooded lead acid (FLA) battery, an enhanced flooded lead acid battery (EFB), or valve regulated lead acid (VRLA) battery, the CMD ribs extend in a direction that is parallel to a top and bottom of the battery. The separator helps reduce acid stratification issues, allowing for FLA batteries to be used as auxiliary batteries or enhanced flooded lead acid batteries (EFB), and further improving VRLA performance when used as auxiliary batteries.

Many different arrangements of the various components and/or steps depicted and described, as well as those not shown, are possible without departing from the scope of the claims below. Embodiments of the present technology have been described with the intent to be illustrative rather than restrictive. Alternative embodiments will become apparent from reference to this disclosure. Alternative means of implementing the aforementioned can be completed without departing from the scope of the claims below. Certain features and sub-combinations are of utility and can be employed without reference to other features and sub-combinations and are contemplated within the scope of the claims.

1. A lead acid battery separator, comprising:
a first array of ribs extending from a first side of a backweb; and
a second array of ribs extending from a second side of the backweb, wherein both the first array of ribs and the second array of ribs are cross-machine direction (CMD) ribs, wherein a siliceous material is provided between the ribs on at least one of the first side or the second side thereof, and the siliceous material is one or more selected from precipitated silica, dry finely divided silica, amorphous silica, fumed silica, friable silica, and dispersible silica.

2. The lead acid battery separator of claim 1, wherein the backweb has a thickness from 100 microns to 400 microns; wherein at least one of the first array of ribs and the second array of ribs comprise individual ribs having different heights; wherein one or both of the first array of ribs and the second array of ribs comprise continuous ribs; wherein one or both of the first array of ribs and the second array of ribs comprise discontinuous ribs; wherein the battery separator is a filled polyolefin lead acid battery separator; wherein an amount of rubber, rubber derivatives, latex, or latex derivatives in the battery separator is from 1% to 3%; wherein the separator is a cut-piece, a sleeved, a wrapped, or an enveloped separator; wherein the separator is a wrapped or an enveloped separator with one or more slits in a bottom; or wherein the battery separator comprises a surfactant and the surfactant is one or more selected from an ionic surfactant, a non-ionic surfactant, and an amphoteric surfactant.

3. The lead acid battery separator of claim 2, wherein an overall thickness of the battery separator is between 600 microns and 1,100 microns.

4. The lead acid battery separator of claim 2, wherein the discontinuous ribs are angled discontinuous ribs.

5. The lead acid battery separator of claim 2, wherein the battery separator comprises a siliceous filler.

6. The lead acid battery separator of claim 5, wherein a ratio of siliceous filler to polyolefin is 2.5:1 to 5:1.

7. The lead acid battery separator of claim 1, wherein an amount of oil in the battery separator is from 5% to 20%.

8. The lead acid battery separator of claim 7, wherein an aniline point of the oil is from 80° C. to 125° C.

9. The lead acid battery separator of claim 1, comprising carbon on at least of the first side and the second side.

10. The lead acid battery separator of claim 1, comprising one or more selected from precipitated silica, dry finely divided silica, amorphous silica, fumed silica, friable silica, dispersible silica, alumina, talc, super absorbent polymer, and fishbone meal between the ribs on at least one of the first side or the second side thereof.

11. A lead acid battery comprising the lead acid battery separator of claim 1, wherein the CMD ribs extend parallel to a top and a bottom of the battery.

12. A lead acid battery comprising the battery separator of claim 11, wherein:
the CMD ribs extend parallel to a top and a bottom of the battery; and wherein the carbon is on a side of the separator that faces a negative electrode of the battery.

13. A lead acid battery comprising the battery separator of claim 1, wherein:
the CMD ribs extend parallel to a top and a bottom of the battery; and wherein the silica is on a side of the separator that faces a positive electrode of the battery.

14. The lead acid battery of claim 13, wherein the lead acid battery is a flooded lead acid battery, including an enhanced flooded battery (EFB), a starting, lighting, ignition (SLI) battery, or the like.

15. The lead acid battery of claim 13, wherein the battery comprises a thickening agent or a gelling agent in an electrolyte of the battery.

16. A vehicle comprising the lead acid battery of claim 13, wherein the lead acid battery is a main lead acid battery or an auxiliary lead acid battery of the vehicle.

17. The vehicle of claim 16, wherein the lead acid battery is the main lead acid battery; wherein the lead acid battery is the auxiliary lead acid battery; or wherein the vehicle is a truck, a car, or an electric car.

18. A valve regulated lead acid (VRLA) battery, comprising a composite battery separator that includes a valve regulated lead acid (VRLA) separator or an absorptive glass mat (AGM) separator and a polyolefin battery separator, wherein an outward facing side of the polyolefin battery separator comprises cross-machine-direction (CMD) ribs that extend parallel to a top and a bottom of the battery.

19. A vehicle comprising the VRLA battery of claim 18, wherein the VRLA battery is a main battery or an auxiliary battery of the vehicle.

20. A lead acid battery comprising:
two positive electrode plates;
a negative electrode plate between the two positive electrode plates; and a separator comprising a backweb, a first array of ribs extending from a first side of the backweb, a second array of ribs extending from a second side of the backweb, and at least one of the first or second array of ribs comprising cross-machine direction (CMD) ribs, wherein
at least one side of the separator is coated with a siliceous material, and the separator encompasses the negative plate so that the CMD ribs face one or both of the positive electrode plates and extend in a direction parallel to a top or bottom of the battery.

21. The battery of claim 20, wherein the siliceous material is one or more selected from the precipitated silica, dry finely divided silica, amorphous silica, fumed silica, friable silica, dispersible silica, and colloidal silica.

22. A lead acid battery comprising:
two positive electrode plates;
a negative electrode plate between the two positive electrode plates; and a
separator encompassing both positive electrode plates, the separator comprising a backweb, a first array of ribs extending from a first side of the backweb, a second array of ribs extending from a second side of the backweb, and at least one of the first or second array of ribs comprising cross-machine direction (CMD) ribs, and at least one side of the separator is coated with a siliceous material,
the CMD ribs face positive electrode plates and extend in a direction parallel to a top or bottom of the battery.

23. The battery of claim 22, wherein the siliceous material is one or more selected from the precipitated silica, dry finely divided silica, amorphous silica, fumed silica, friable silica, dispersible silica, and colloidal silica.

24. A lead acid battery comprising:
at least one positive electrode plate;
at least one negative electrode plate; and
a battery separator, wherein a profile on at least one side of the battery separator exhibits a surface area increase compared to a flat separator that is 35% or more, and wherein silica is coated on at least one side of the battery separator.

25. The lead acid battery of claim 24, wherein the surface area increase is greater than 40%; wherein the surface area increase is greater than 60%; or wherein the surface area increase is greater than 80%.

26. The lead acid battery of claim 24, wherein silica is coated on two sides of the battery separator.

27. A lead acid battery separator, comprising:
a polyolefin backweb; and
a silica coating on at least one side of the backweb.

28. The separator of claim 27, having a silica coating on both sides of the backweb; having a carbon coating on the other side of the backweb; having ribs or protrusions on at least one side of the backweb; having a 10 to 500 micron backweb thickness; or having a 10 to 1,200 micron overall separator thickness including any ribs.

29. The lead acid battery separator of claim 1, wherein the backweb has a thickness from 8 microns to 500 microns, 10 microns to 500 microns, 50 microns to 400 microns, or 100 microns to 400 microns.

30. The lead acid battery separator of claim 29, wherein an overall thickness of the battery separator is between 8 to 1,200 microns, 10 to 1,200 microns, 50 to 1,100 microns, or 600 to 1,100 microns.

31. The lead acid battery separator of claim 1, wherein the backweb has a thickness between about 100 microns to about 400 microns, from 100 microns to 350 microns, from 100 microns to 300 microns, from 100 microns to 250 microns, from 100 microns to 200 microns, or from 100 microns to 150 microns.

32. The lead acid battery separator of claim 1, wherein an overall thickness of the battery separator is from about 500 microns to about 1,100 microns, from 500 microns to 1,000 microns, from 500 microns to 900 microns, from 500 microns to 800 microns, from 500 microns to 700 microns, from 500 microns to 600 microns, or between about 600 microns and 1,000 microns,

33. A flat sheet or non-ribbed polyolefin membrane, comprises:
a polyolefin backweb; and
a silica coating on at least one side of the backweb.

34. The flat sheet of claim 33, having a silica coating on both sides of the backweb; having a carbon coating on the other side of the backweb; or having a 10 to 500 micron backweb thickness.
